(19) United States
(12) Patent Application Publication
(10) Pub. No.: US 2007/0143486 A1
(43) Pub. Date: Jun. 21, 2007

(54) Method and apparatus for supporting user mobility by allowing guest access in internet service network, and billing method based on the same

(76) Inventors: Kuk Chang Kang, Daejeon (KR); Soon Seok Lee, Daejeon (KR); Young Sun Kim, Daejeon (KR)

Correspondence Address: LADAS & PARRY LLP, 224 SOUTH MICHIGAN AVENUE, SUITE 1600, CHICAGO, IL, 60604, US

(21) Appl. No.: 11/524,971

(22) Filed: Sep. 21, 2006

(30) Foreign Application Priority Data
Nov. 29, 2005 (KR) 10-2005-0114568

(51) Int. Cl. G06F 15/16

(52) U.S. Cl. 709/229

(57) ABSTRACT

A method and apparatus for supporting user mobility by allowing guest access in an Internet service network and a billing method based on the same are provided. The method for supporting user mobility by allowing guest access in an Internet service network includes the steps of: performing user authentication and querying a subscriber DB to determine whether a user is a host user or a guest user when a subscriber ID is inputted; querying the subscriber DB to determine whether there is an available bandwidth for the guest user when the user is the guest user; and querying the subscriber DB to provide a service package corresponding to the guest user when there is an available bandwidth for the guest user.

### CROSS-REFERENCE TO RELATED APPLICATION

This application claims the benefit of Korean Patent Application No. 2005-114568, filed Nov. 29, 2005, the disclosure of which is hereby incorporated herein by reference in its entirety.

### BACKGROUND

1. Field of the Invention

The present invention relates to a method and apparatus for supporting user mobility by allowing guest access in an Internet service network and a billing method based on the same, and more particularly, to a method and apparatus for supporting user mobility by allowing guest access in an Internet service network in which a plurality of subscriber IDs can be assigned to a single subscriber line and managed and a billing method based on the same.

2. Discussion of Related Art

In an existing Internet service, just one subscriber ID is assigned to one subscriber line, and so a single service providing and billing policy is applied to the same subscriber line.

That is, the existing Internet service assigns one subscriber ID to one subscriber line, and a provided service and a service fee belong to a possessor or contractor of the subscriber line. Billing for the subscriber line is done regardless of who has used the subscriber line, and thus there is a problem in that the service providing and billing policy is not fairly and reasonably done.

Besides, a next generation network (NGN) provides a premium service which guarantees a quality requirement of each service at a consistent level, and it is expected that a usage-based billing system will be a basic billing system in the NGN network. Thus, there is a need for a reasonable billing policy.

In particular, in the premium service described above, each user selects services, which the user desires to use, to constitute a service package. However, the user can not be provided with the user's service package through another person's subscriber line because only one service package is allowed to one subscriber line.

In other words, the user can access the Internet through another person's subscriber line, but only the service package allocated to the corresponding subscriber line is provided because the service provider can not be aware of who has used the corresponding subscriber line.

That is, the existing Internet service does not consider a guest user who uses another person's subscriber line and so cannot help to provide a restricted business model which entirely depends on the subscriber line.

For the foregoing reason, there is a need for a means for allowing the user to use the user's service package through another person's subscriber line in order to provide a new-type service in which both the subscriber line and the user mobility are considered.

### SUMMARY OF THE INVENTION

The present invention is directed to a method and apparatus for supporting user mobility in which a plurality of subscriber IDs can be assigned to one subscriber line and managed to allow guest access, so that the guest user can be provided with the user's service package through another person's subscriber line, and a billing method based on the same.

In an exemplary embodiment of the present invention, there is provided a method for supporting user mobility by allowing guest access in an Internet service network, the method comprising the steps of: performing user authentication and querying a subscriber DB to determine whether a user is a host user or a guest user when a subscriber ID is inputted; querying the subscriber DB to determine whether there is an available bandwidth for the guest user when the user is the guest user; and querying the subscriber DB to provide a service package corresponding to the guest user when there is an available bandwidth for the guest user.

In a preferred embodiment of the present invention, the method may further include the steps of: obtaining a circuit ID to recognize a subscriber line accessed by the user when a user terminal accesses; and recording and managing the subscriber ID, bandwidth use information, and service package information of the user accessing a corresponding subscriber line in the subscriber DB based on the circuit ID.

In another preferred embodiment, the step of obtaining the circuit ID may include: a first step of adding a MAC address of the user terminal and the circuit ID to a DHCP packet to transmit the DHCP packet to a DHCP server; a second step of allocating an IP address by the DHCP server; and a third step of binding the IP address and the circuit ID together to temporarily store them in a memory.

In still another preferred embodiment, the circuit ID information may be added to a client identifier which is an option field of the DHCP packet.

In yet another preferred embodiment, the step of querying the subscriber DB to determine whether there is an available bandwidth for the guest user when the user is the guest user may include: a first step of retrieving physical bandwidth information or contracted bandwidth information of a corresponding subscriber line from the subscriber DB; a second step of determining whether there is an available bandwidth for the guest user based on the physical bandwidth information or the contracted bandwidth information of the subscriber line; and a third step of adjusting a bandwidth of the corresponding subscriber line to allocate a bandwidth resource to the guest user.

In yet another preferred embodiment, the third step of adjusting a bandwidth of the corresponding subscriber line may include allocating a bandwidth for the guest user separately from a bandwidth for the host user by using a rate-limiting function for the subscriber line when the physical bandwidth of the corresponding subscriber line is greater than the contracted bandwidth.

In yet another preferred embodiment, the subscriber DB may include fields for: circuit ID information of a subscriber line; subscriber ID information for host and guest users; IP address information of the subscriber line; physical bandwidth information of the subscriber line; contracted bandwidth information for the host and guest users; reserved bandwidth information for the host and guest users; available bandwidth information for the host and guest users; and service package information for the host and guest users.

### BRIEF DESCRIPTION OF THE DRAWINGS

The above and other features of the present invention will be described in reference to certain exemplary embodiments thereof with reference to the attached drawings in which:

FIG. 1 is a schematic diagram illustrating a configuration of a network to which the present invention is applied;

FIG. 2 is a flowchart illustrating a procedure for obtaining circuit ID information according to an embodiment of the present invention;

FIG. 3 shows an embodiment in which resources are allocated to a guest user based on a contracted bandwidth of a subscriber line;

FIG. 4 shows an embodiment in which resources are allocated to the guest user based on a physical bandwidth of the subscriber line;

FIG. 5 shows a flowchart illustrating a method for allowing guest access;

FIG. 6 shows the structure of a subscriber DB when the guest user is accommodated based on the contracted bandwidth of a host user;

FIG. 7 shows the structure of a subscriber DB when the guest user is accommodated based on the physical bandwidth of the host user; and

FIG. 8 is a flowchart simply illustrating a procedure from IP address allocation and use authentication to billing data calculation in allowing the guest access according to an embodiment of the present invention.

### DETAILED DESCRIPTION OF PREFERRED EMBODIMENTS

The present invention will now be described more fully hereinafter with reference to the accompanying drawings, in which preferred embodiments of the invention are shown.

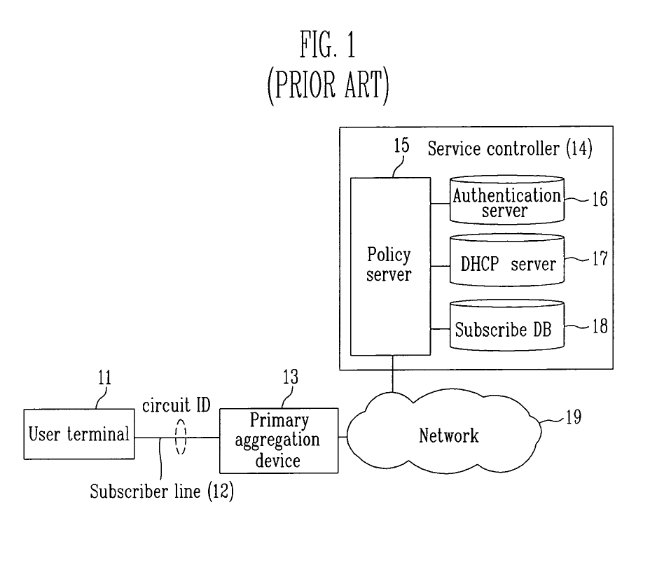

FIG. 1 is a schematic diagram illustrating a configuration of a network to which the present invention is applied.

Referring to FIG. 1, the present invention can be applied to a network which includes a user terminal 11 such as a DSL modem or a cable modem, a primary aggregation device 13 such as a digital subscriber line access multiplexer (DSLAM) or a cable modem termination system (CMTS), a subscriber line 12 for connecting the subscriber terminal 11 to the primary aggregation device 13, a service controller 14 for performing functions related to a service, a service level agreement (SLA) and a subscriber-related policy, and an IP network for providing different service packages according to each subscriber ID.

The service controller 14 preferably includes a policy server 15 for performing a subscriber-related policy function, an authentication server 16 for checking a subscriber ID and a password to determine whether to authenticate access of the user to the network, a DHCP server 17 for allocating an IP address in response to a user terminal's request, and a subscriber DB 18 for storing subscriber-related information.

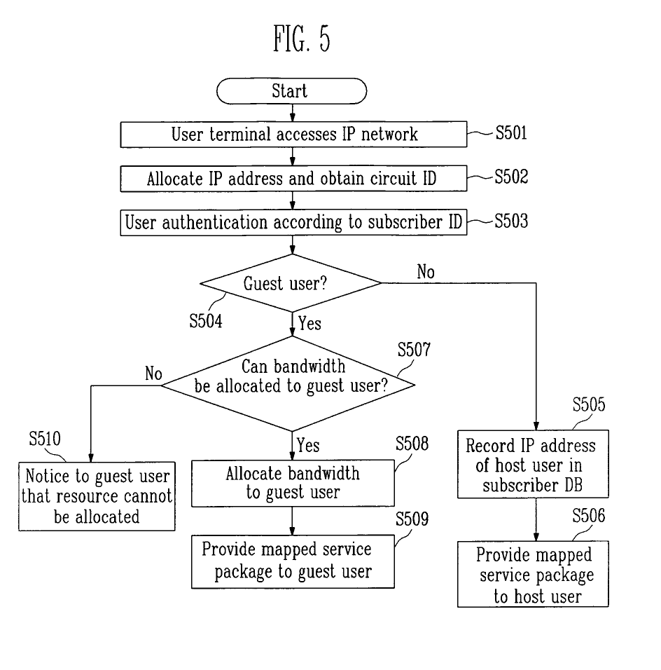

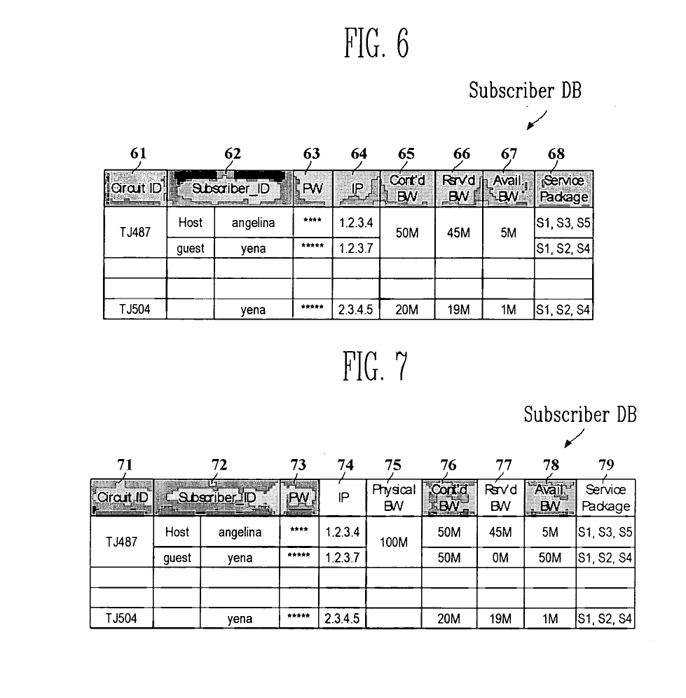

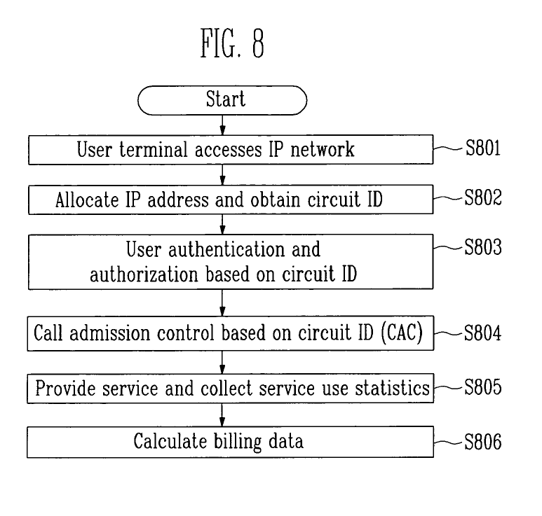

The subscriber DB 18 is a recording medium for binding and storing a circuit ID, a subscriber ID, and an IP address of a service user, and stores all information necessary for the entire service procedure from authentication to billing. Supplemental information necessary for implementing the present invention can be managed through a separate recording medium in addition to the existing subscriber DB, but it is assumed that the supplemental information is stored in the subscriber DB having an improved structure for description convenience. A structure of the subscriber DB will be explained in detail later with reference to FIGS. 6 and 7.

In order to support the user mobility between the different subscriber lines in the IP network of FIG. 1, it is necessary to perceive who uses a corresponding subscriber line and which kind of service can be provided to the user through the corresponding subscriber line.

That is, it is necessary to identify the subscriber line and the user which accesses the Internet through the corresponding subscriber line, and it is also necessary to authenticate access of the user through another person's subscriber line and provide a corresponding service.

To this end, in the present invention, a circuit ID for identifying a subscriber line, a subscriber ID and an IP address are bound to, recorded and managed in the subscriber DB 18 so that the subscriber DB 18 can be used to determine whether a user who accesses through the subscriber line is a host user or a guest user and to perform access authentication for guest access allowance and service provision. The circuit ID and the subscriber DB will be explained later in detail.

The circuit ID is an identifier for identifying the subscriber line 12 which connects the user terminal II such as a DSL modem or a cable modem to the primary aggregation device 13. In the present invention, the subscriber line and the user access line are the same in meaning. Preferably, an ID unique to each subscriber line is allocated when the user subscribes to the network provider for the first time.

The unique circuit ID allocated to the subscriber line is obtained at a time when the user terminal II first accesses to the network 19 to be allocated an IP from the DHCP server 17. A MAC address of the user terminal and the circuit ID are transmitted together when the user terminal requests to allocate the IP address, and the service controller 14 binds the allocated IP address and the circuit ID together to record them in the subscriber DB 18, and binds the circuit ID, the subscriber ID, and the IP address together to record them in the subscriber DB 18 when the subscriber ID is obtained in the authentication procedure performed by the authentication server 16.

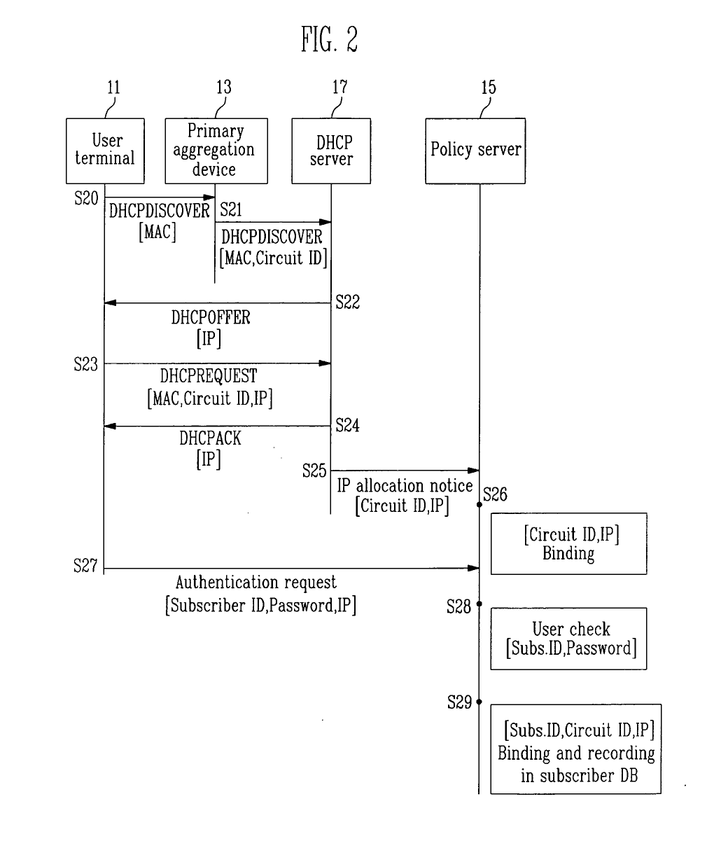

A method for obtaining the circuit ID will be explained in greater detail below with reference to FIG. 2.

FIG. 2 is a flowchart illustrating a procedure for obtaining the circuit ID information according to the present invention. In particular, FIG. 2 shows a method for obtaining the circuit ID information in the authentication and IP allocation procedure.

Typically, the network providers allocate the subscriber number (i.e., subscriber ID) unique to the subscriber line and manage information about the physical location and line characteristics of the subscriber line together with the subscriber-related information based on the subscriber ID.

Based on a given circuit ID unique to the subscriber line, contracted speed information and physical speed information of each subscriber line should be managed together. For example, the subscriber number currently managed by the network providers is unique to each subscriber and can be used as the circuit ID as it is.

Referring to FIG. 2, when the user turns on the user terminal to access the network, the DHCP client, i.e., the user terminal 11 transmits a DHCPDISCOVER message containing the MAC address (S20), and the primary aggregation device 13 adds the circuit ID information to the DHCPDISCOVER message and transmits the DHCPDISCOVER message containing the MAC address and the circuit ID information (S21) to the DHCP server 17.

That is, while in the conventional network, the user transmits the MAC address to the DHCP server through the DHCP packet to be allocated the IP, in the present invention, the circuit ID is added to the DHCP packet together with the MAC address and then transmitted to the DHCP server 17.

Adding the MAD address and the circuit ID to the DHCP packet is performed by inserting the circuit ID into a client identifier which can be defined by an option field of the DHCP message. This can be applied to both the JPv4 and the IPv6.

The function for inserting the circuit ID information into the DHCP packet belongs to the user terminal or the primary aggregation device 13. Since the user terminal 11 does not always access the same subscriber line, the user terminal is improper in view of the user mobility; however, the primary aggregation device 13 knows all of the subscriber lines, i.e., physical ports connected to itself and thus can identify through which port the DHCP packet is transmitted and insert the circuit ID information into the DHCP packet. Thus, the primary aggregation device 12 preferably has the function for adding the circuit ID information to the DHCP packet.

Thereafter, the DHCP server 17 selects an appropriate IP address to responsively transmit a DHCPOFFER message (S22), and the user terminal 11 confirms the provided IP address through the DCHPREQUEST (S23). The DHCP server 17 transmits a DHCPACK message to confirm that allocation of the IP address is completed (S24).

Meanwhile, the policy server 15 receives the IP address allocated from the DHCP server 17 and the circuit ID information corresponding to the IP address and binds the information together to temporarily store them in a memory (S25 to S26). When the subscriber who is allocated the IP address transmits the subscriber ID and the password to the policy server 15 for network authentication (S27), the policy server 15 retrieves them from the subscriber DB 18 to authenticate the subscriber (S28) and binds the circuit ID, the subscriber ID and the IP address together to record them in the subscriber DB 18 (S29).

As described above, since information about the physical subscriber line of the user is obtained through the circuit ID obtaining and binding procedures, it is possible to discriminate whether the user is the host user or the guest user by determining whether the subscriber ID inputted from the user terminal 11 is the subscriber ID corresponding to the circuit ID or not through the user authentication procedure, whereby readiness to provide the service specific to the user is completed.

In this embodiment, it has been explained that allocation of the IP address is performed before the authentication procedure. However, the authentication procedure can be performed before the IP address is allocated to only the authenticated subscribers. In this case, the subscriber ID information is obtained first, and then the circuit ID information and the IP address information are obtained in the process of allocating the IP address so that the circuit ID information and the IP address information are bound to the subscriber ID. That is, the present invention can be applied to both cases, and the order of the authentication and the IP address allocation may depend on the policy of the network provider.

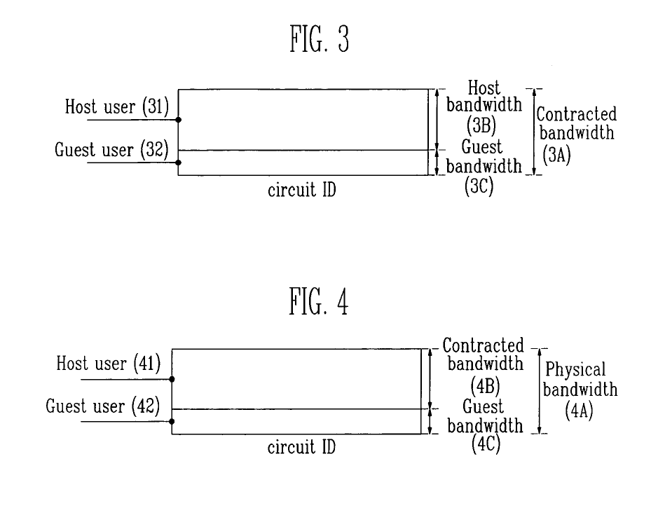

A method for accommodating guest users can be selected depending on how to operate the subscriber lines, which will be now described with reference to FIGS. 3 and 4.

FIG. 3 shows an embodiment in which resources are allocated to a guest user based on the contracted bandwidth of the subscriber line, and FIG. 4 shows an embodiment in which resources are allocated to a guest user based on the physical bandwidth of the subscriber line.

Typically, there may be a difference between the physical bandwidth and the contracted bandwidth of the subscriber line. For example, even though the capacity of the subscriber line is 50 Mbps, a contracted capacity of 20 Mbps can be provided by rate-limiting according to a contract. Conversely, the network provider physically installs the subscriber line of 50 Mbps to the subscriber who requests the subscriber line of 20 Mbps and then can limit the subscriber line to 20 Mbps using the rate-limiting function of the primary aggregation device 13.

In FIG. 3, an embodiment is illustrated in which resources are allocated to the guest user within the contracted bandwidth originally allocated to the subscriber line. That is, an available bandwidth excluding the bandwidth currently used by the host subscriber 21, i.e., the host bandwidth 3B from the contacted bandwidth 3A is used as the guest bandwidth 3C to accommodate the guest user 32.

In FIG. 4, an embodiment is illustrated in which resources are allocated to the guest user based on the physical bandwidth. For example, if the physical bandwidth 4A is 50 Mbps and the contracted bandwidth 4B is 20 Mbps, resources of the remaining 30 Mbps are allocated to the guest user 42.

As shown in FIG. 4, resources are allocated to the guest user based on the physical bandwidth while keeping resource for the host user as it is. It gives the Internet service provider an opportunity to create new revenue.

In FIG. 4, when the physical bandwidth 4A is identical to the contracted bandwidth 4B, the resource allocation can be performed in the same way as FIG. 3, and in order to accommodate the guest user using the method of FIG. 4, the primary aggregation device should have the rate limiting function for dynamically adjusting the bandwidth.

The quest user accommodating methods of FIGS. 3 and 4 can be applied to the case where the number of the guest users is 2 or more. In this case, the resources are allocated to each guest user by the same method.

FIG. 5 shows a flowchart illustrating a method for allowing guest access. For description convenience, it is assumed that the guest user is accommodated based on the network of FIG. 1.

First, when the user terminal 11 accesses the IP network 19 (S501), the service controller 14 allocates an IP address through the DHCP server 17 and obtains the circuit ID in the IP address allocating process to thereby recognize the subscriber line through which the user accesses to the IP network 19 (S502). The circuit ID and the IP address are bound and stored in the memory.

Upon receipt of the subscriber ID from the user terminal 11, the service controller 14 authenticates the user through the authentication server 16 (S503) and retrieves the circuit ID and the subscriber ID from the subscriber DB to determine whether the user is the host user or the guest user (S504).

When the user is determined as the host user, the IP address allocated to the host user is recorded in the user DB (S505), and then the service package corresponding to the host user is provided to the user by referring to the subscriber DB 18 (S506).

On the other hand, when the user is determined as the guest user, a determination is made as to whether there is a bandwidth resource of the corresponding subscriber line which can be allocated to the guest user (S507). When there is an available bandwidth resource which can be allocated to the guest user, the bandwidth of the corresponding subscriber line is adjusted to allocate a predetermined bandwidth resource to the guest user (S508). The login information (subscriber ID and password) of the guest user, the IP address, and the bandwidth use information are bound to the corresponding circuit ID and recorded in the subscriber DB 18.

Thereafter, the service controller 14 provides the guest user with the corresponding service package by referring to the subscriber DB 18 (S509).

Meanwhile, if the resources cannot be allocated to the guest user, this fact is notified to the guest user to block the guest access (S510).

FIGS. 6 and 7 show the structure of a subscriber DB according to guest user accommodation. FIG. 6 shows the structure of the subscriber DB when the guest user is accommodated based on a contracted bandwidth of the host user, and FIG. 7 shows the structure of the subscriber DB when the guest user is accommodated based on the physical bandwidth of the host user.

Referring to FIG. 6, when the guest user is accommodated based on the contracted bandwidth of the host user, the subscriber DB includes a circuit ID field 61, a subscriber ID field 62, a password (PW) field 63, an IP address field 64, a contracted bandwidth (Cont'd BW) field 65, a reserved bandwidth (Rsrv'd BW) field 66, an available bandwidth field 67, and a service package field 68. The service package field 68 is bound to and recorded in each subscriber ID.

As shown in FIG. 6, when the guest user (subscriber ID: yena) accesses the IP network using the subscriber line (circuit ID: TJ487) 61 of the host user (subscriber ID: angelina), the login information 62 and 63 of the guest user and the IP address 64 are bound to the circuit ID 61 of the host user and then recorded, and the guest user shares the contracted bandwidth of the host user to be provided with services for the service packages S1, S2 and S4.

Referring to FIG. 7, when the guest user is accommodated based on the physical bandwidth of the host user, unlike the subscriber DB of FIG. 6, the subscriber DB additionally has a physical bandwidth field 75 of the subscriber line, the contracted bandwidth field 76 of each of the host user and the guest user, the reserved bandwidth field 77, the available bandwidth field 78, and the service package field 79. The login information 72 and 73 of the guest user and the information about the service package are bound to the circuit ID 71 and then are recorded in the subscriber DB like that of FIG. 6.

Here, the contracted bandwidth of the guest user is a temporarily contracted bandwidth and can be set independently of the contract of the subscriber line (TJ504) that the guest user contracted with the network provider.

As shown in FIG. 7, the guest user (subscriber ID: yena) can be provided with his/her service package through the subscriber line (TJ487) 71 of the host user (subscriber ID: angelina). The bandwidth for the guest user can be separately allocated using the physical surplus capacity of the subscriber line while maintaining the contracted bandwidth of the host user, and the guest user is not always allocated the whole surplus bandwidth but allocated within the surplus bandwidth.

FIG. 8 is a flowchart illustrating a procedure from the IP address allocation to the user authentication in allowing the guest access according to an embodiment of the present invention. It is assumed that bandwidth use information of the user is recorded in the subscriber DB based on the circuit ID.

When the user terminal 11 accesses the IP network 19 (S801), the service controller 14 allocates the IP address through the DHCP server 17 and obtains the circuit ID in the IP address allocation process to recognize the subscriber line accessed by the user (S802). The circuit ID and the IP address are bound to each other and recorded in the memory.

Upon receipt of the subscriber ID from the user terminal 11, the service controller 14 then authenticates the user through the authentication server 16 and authenticates the user's right based on the circuit ID (S803). The authentication of the user's right is to check a right the user can use the corresponding subscriber line, and is performed by retrieving the circuit ID and the subscriber ID from the subscriber DB 18 to check whether the user is the host user or the guest user.

That is, a different service package is provided to the corresponding IP address according to whether the user is the host user or the guest user.

Next, when the service requested by the host user or the guest user is a guaranteed-rate service which requires a predetermined bandwidth, a call admission control (CAC) process is performed based on the circuit ID (S804).

The CAC is to allow the network access only when a resource reservation for the IP communication service having a predetermined bandwidth requirement is possible. Various CAC techniques have been developed to guarantee quality of the Internet service. In the present invention, a call is accepted only when it is determined that the user side has a surplus bandwidth based on the circuit ID, thereby guaranteeing the Internet service quality.

When a call is accepted according to the CAC procedure based on the circuit ID, the service package corresponding to the user is provided by referring to the subscriber DB 18, and the service use statistics is collected (S805). The service use statistics is collected based on the subscriber ID through which the service is actually provided, and when the collected service use statistics information is transmitted to the billing server (not shown), billing data for each subscriber line is calculated for the user which uses the service (S806).

As described above, in order to implement the present invention, the primary aggregation device should be changed in software so that circuit ID information is inserted into the DHCP packet in allocating the IP address of the user terminal, and a recording medium capable of managing the information about the host/guest user and the bandwidth use information based on the circuit ID is required. This can be simply achieved by disposing a separate recording medium or changing the structure of an existing subscriber DB. That is, the present invention can be implemented by upgrading the existing device in software or improving the structure of the existing subscriber DB.

In other words, the present invention can be implemented without using a separate device or changing any protocol by suggesting the method for discriminating a physical access environment of the service user based on a unique identifier such as a circuit ID and the new subscriber DB structure for managing a bandwidth use specification and a host/guest user's right to use the service based on the circuit ID. Thus, a single subscriber line can accommodate a plurality of guest users, thereby supporting user mobility between the subscriber lines.

The embodiments of the present invention described above can be implemented by a computer-executable program and can be implemented by a universal computer which executes the program through a computer-readable recording medium.

The computer-readable recording medium includes a magnetic recording medium (e.g., ROM, floppy disk, and hard disk, etc.), an optical readable medium (e.g., CD-ROM and DVD, etc.), and a carrier wave (e.g., Internet-based transmission).

As described above, compared to the conventional art that totally depends on the subscriber line, the present invention has an effect in that the user can be provided with his/her service package through another person's subscriber line since a single subscriber can accommodate a plurality of users, whereby the user mobility between the subscriber lines is supported.

That is, the present invention has the following advantages in that the new business model in which billing is done based on the actual user can be created.

First, it is possible to realize a business model that a user is allowed to access another person's subscriber line to obtain his/her service package, by supporting user mobility between the subscriber lines. This can increase service use by users and increase the use of premium service based on the usage-based billing system, leading to convenience of the service use to the user and a profit to network providers.

Second, it is possible to increase utilization of available resources by additionally allocating a bandwidth within the physical bandwidth of the subscriber line to a guest user in accommodating the guest user. This gives network providers an opportunity to create new revenue.

Further, the present invention suggests the method for obtaining the circuit ID using the existing DHCP packet as it is and the method for managing the bandwidth use based on the circuit ID by changing the existing subscriber DB a little. Thus, the present invention can be implemented without adding a separate supplemental device or changing any protocol. Furthermore, the guest access allowing method of the present invention has only the user discriminating procedure and the subscriber line bandwidth managing procedure added to the conventional network system. Thus, the present invention can be easily applied to the conventional network system since the conventional network can be maintained as it is.

Although the present invention has been described with reference to certain exemplary embodiments thereof, it will be understood by those skilled in the art that a variety of modifications and variations may be made to the present invention without departing from the spirit or scope of the present invention defined in the appended claims, and their equivalents.

What is claimed is:

1. A method for supporting user mobility by allowing guest access in an Internet service network, the method comprising the steps of:
(a) performing user authentication and querying a subscriber DB to determine whether a user is a host user or a guest user when a subscriber ID is inputted;
(b) querying the subscriber DB to determine whether there is an available bandwidth for the guest user when the user is the guest user; and
(c) querying the subscriber DB to provide a service package corresponding to the guest user when there is an available bandwidth for the guest user.

2. The method of claim 1, further comprising the steps of:
(d) obtaining a circuit ID to recognize a subscriber line accessed by the user when a user terminal accesses; and
(e) recording and managing the subscriber ID, bandwidth use information, and service package information of the user accessing a corresponding subscriber line in the subscriber DB based on the circuit ID.

3. The method of claim 2, wherein step (d) comprises:
a first step of adding a MAC address of the user terminal and the circuit ID to a DHCP packet to transmit the DHCP packet to a DHCP server;
a second step of allocating an IP address by the DHCP server; and
a third step of binding the IP address and the circuit ID together to temporarily store them in a memory.

4. The method of claim 3, wherein the first step comprises inserting the circuit ID information into a client identifier which is an option field of the DHCP packet to transmit the circuit ID information to the DHCP server.

5. The method of claim 1, wherein step (b) comprises:
a first step of retrieving physical bandwidth information or contracted bandwidth information of a corresponding subscriber line from the subscriber DB;
a second step of determining whether there is an available bandwidth for the guest user based on the physical bandwidth information or the contracted bandwidth information of the subscriber line; and
a third step of adjusting a bandwidth of the corresponding subscriber line to allocate a bandwidth resource to the guest user.

6. The method of claim 5, wherein the third step comprises allocating a bandwidth for the guest user separately from a bandwidth for the host user by using a rate-limiting function for the subscriber line when the physical bandwidth of the corresponding subscriber line is greater than the contracted bandwidth.

7. An apparatus for supporting user mobility by allowing guest access in an Internet service network, the apparatus comprising a service controller for allowing and managing a plurality of subscriber IDs to be accommodated in a single subscriber line,
wherein the service controller performs user authentication and queries a subscriber DB to determine whether a user is a host user or a guest user when a subscriber ID is inputted, queries the subscriber DB to determine whether there is an available bandwidth for the guest user when the user is the guest user, and queries the subscriber DB to provide a service package corresponding to the guest user when there is an available bandwidth for the guest user.

8. The apparatus of claim 7, wherein the service controller comprises a DHCP server for allocating an IP address,
wherein when receiving a DHCP packet containing a MAC address and a circuit ID from a user terminal, the DHCP server assigns an IP address and binds the IP address and the circuit ID together to temporarily store them in a memory.

9. The apparatus of claim 8, wherein the circuit ID information is inserted into a client identifier which is an option field of the DHCP packet and transmitted to the DHCP server.

10. The apparatus of claim 7, wherein the subscriber DB comprises fields for:
circuit ID information of a subscriber line;
subscriber information for host and guest users;
IP address information of the subscriber line;
contracted bandwidth information for the host and guest users;
reserved bandwidth information for the host and guest users;
available bandwidth information for the host and guest users; and
service package information for the host and guest users.

11. A billing method based on user mobility support in an Internet service network, the method comprising the steps of:
performing user authentication and querying a subscriber DB to determine whether a user is a host user or a guest user when a subscriber ID is inputted;
querying the subscriber DB to determine whether there is an available bandwidth for the guest user when the user is the guest user;
querying the subscriber DB to provide a service package corresponding to the guest user when there is an available bandwidth for the guest user;
collecting service package use statistics based on the subscriber ID; and
calculating billing data based on the subscriber ID based on the collected service package use statistics.
